(19) United States
(12) Patent Application Publication
(10) Pub. No.: US 2020/0107910 A1
(43) Pub. Date: Apr. 9, 2020

(54) ORTHODONTIC APPLIANCE AND METHOD FOR MANUFACTURING SUCH AN APPLIANCE

(71) Applicant: NUTISLAB, BIARRITZ (FR)

(72) Inventors: Laurent CHAZALON, BAYONNE (FR); Julien BRETON, SARE (FR); Véronique PECHEVIS, BIDART (FR)

(21) Appl. No.: 16/617,923

(22) PCT Filed: May 31, 2018
(86) PCT No.: PCT/EP2018/064385

§ 371 Date: Nov. 27, 2019

(30) Foreign Application Priority Data
Jun. 1, 2017 (FR) 1754874

(51) Int. Cl. A61C 7/08; A61C 9/00; A61C 19/05; A61C 13/34

(52) U.S. Cl. CPC A61C 7/08; A61C 13/34; A61C 19/05; A61C 9/004

(57) ABSTRACT

The invention relates to an orthodontic appliance for a patient including a support of which at least one outer surface is shaped to conform to the shape of the patient's palate when the support is placed against the palate, and a peripheral rim of said support intended to be arranged at least facing a palatal face of the upper dental arch when the support is placed against the palate. The invention also relates to a method for manufacturing such an orthodontic appliance.

The present invention relates to an orthodontic appliance.

The invention also relates to a method for manufacturing such an orthodontic appliance.

### BACKGROUND OF THE INVENTION

In humans, the buccal organ consists of the vestibule and the buccal cavity, separated from each other by dental arches. The upper jaw, sometimes called the jawbone, carries the upper arch and the lower jaw, sometimes called the mandible, carries the lower arch. In a patient with normal dental occlusion, the lower and upper dental arches are approximately of the same size so that when the upper and lower jaws are shut, the upper dental arch rests on the lower dental arch.

On the other hand, in a patient with a malocclusion, it is not uncommon for poor placement of the patient's tongue to be the main cause.

Indeed, the tongue should normally be positioned in the buccal cavity so that its tip touches the palate when the tongue is at rest but also when swallowing. This learning of the right language placement is normally innate and takes place over the first years of a child's life.

However, this learning is not always done, or is not done correctly, and some children maintain a position of the tongue such that the child presses on the upper and/or lower dental arch at rest or during swallowing. This eventually leads to deformation of the dental arches and therefore to a corresponding malocclusion.

In order to solve this problem, it is possible to work with a speech therapist who will teach the child how to position his/her tongue correctly in the buccal cavity.

It is also possible to use orthodontic appliances specifically designed for lingual rehabilitation.

Nevertheless, these appliances are generally heavy, bulky and therefore uncomfortable to wear during rehabilitation sessions.

### PURPOSE OF THE INVENTION

One of the aims of the invention is to provide an orthodontic appliance with a reduced volume for a patient.

The invention also relates to a method for manufacturing such an orthodontic appliance.

### GENERAL DEFINITION OF THE INVENTION

To reach this goal, an orthodontic appliance for a patient is proposed, which comprises:
a support of which at least one outer surface is shaped to conform to the shape of the patient's palate, the support being intended to be positioned against the patient's palate,
a peripheral rim of said support intended to be arranged at least facing a palatal face of the upper dental arch when the support is placed against the palate.

In this way, thanks to the particular conformation of the support, a patient can easily position the support against the palate, thus allowing the orthodontic appliance to be held by simply adhering to the palate.

Optionally, the orthodontic appliance is shaped to fully extend into the patient's buccal cavity.

In this position the orthodontic appliance extends behind at least the upper dental arch. The appliance is thus easy to position and does not (or not much) interfere with the patient's jaw closure making the appliance very ergonomic for the patient.

In addition, since the appliance does not extend facing the vestibular surface of the upper dental arch, it is not very visible from the outside, which makes it more aesthetic.

It can thus be envisaged that the patient wears the appliance on a daily basis, allowing for faster and more effective rehabilitation.

According to a particular embodiment, the inner surface of the support is shaped to reproduce the shape of the palate.

In a particular embodiment, the peripheral rim is smooth.

According to a particular embodiment, the rim globally has the shape of a U.

According to a particular embodiment, the rim has a height greater than a height of the upper dental arch in order to extend beyond the occlusion plane.

According to a particular embodiment, the rim extends at least over the combined height of the upper and lower dental arch.

According to a particular embodiment, the rim extends between 1 mm and 3 mm back from a palatal face of the upper dental arch.

According to a particular embodiment, the appliance has a reception area for the patient's tongue with an orifice.

According to a particular embodiment, the appliance has a reception area for the patient's language, the reception area having a raised area.

According to a particular embodiment, the reception area is conformed in a drawing.

The invention relates to a method for manufacturing an orthodontic appliance comprising the following steps:
obtaining a three-dimensional impression of at least part of the patient's buccal cavity,
creating in said impression at least one plane at the occlusal surfaces of the two dental arches of said impression to model at least a part of the patient's palate,
creating a three-dimensional model of the orthodontic appliance,
creating the orthodontic appliance from said model.

Optionally, the plane is created so that it crosses as many teeth as possible.

Optionally, the plane is created so that it crosses first and foremost the most turned-in teeth in the buccal cavity.

Optionally, at least two other planes are created in the impression, one associated with the upper and the other with the lower dental arch to model at least part of the patient's palate.

Optionally, a curve is defined that passes through at least five points of the plane.

Optionally, the palatal papilla and lateral rims of the mandible are also taken into account for the three-dimensional modelling of the orthodontic appliance.

Other characteristics and advantages of the invention will become clearer in the light of the description that follows and the attached drawings, concerning particular embodiments of the invention.

### BRIEF DESCRIPTION OF THE DRAWINGS

Reference will now be made to the appended drawings, wherein:

FIG. 1 is a schematic perspective view of an orthodontic appliance according to a first embodiment of the invention;

FIG. 2 is a perspective view of the orthodontic appliance shown in FIG. 1 in a second orientation,

FIG. 3 is a perspective view of the orthodontic appliance shown in FIG. 1 in a third orientation,

FIGS. 4 to 6 illustrate different steps of a specific method for manufacturing the appliance illustrated in FIG. 1,

FIG. 7 is a perspective view of an orthodontic appliance according to a second embodiment of the invention.

### DETAILED DESCRIPTION OF SPECIFIC EMBODIMENTS OF THE INVENTION

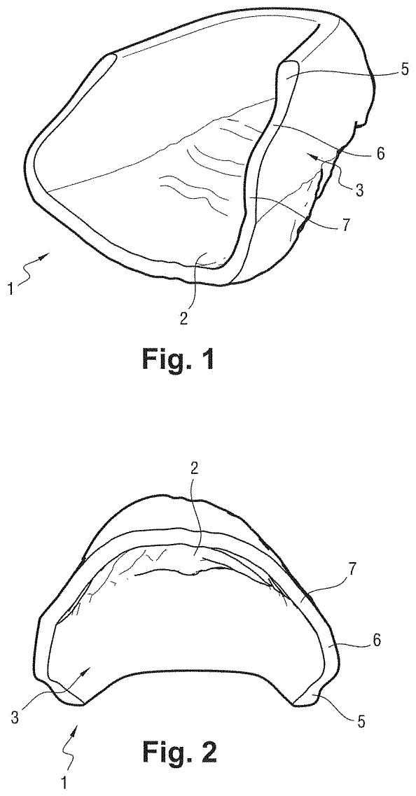

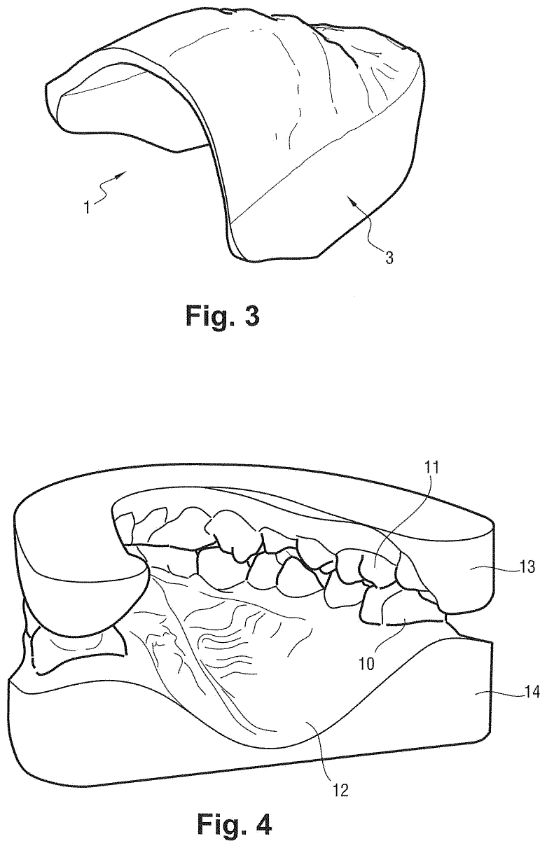

With reference to FIGS. 1 to 3, the orthodontic appliance according to a first embodiment of the invention, generally referred to as 1, is used here for the lingual rehabilitation of a patient. This application is of course not exhaustive and the appliance 1 can be used for another application such as for example to enlarge dental arches.

The appliance 1 includes a support 2 with a main outer face and a main inner face. The appliance 1 is thus shaped so that when the main outer face rests against the patient's palate, it is adjusted to the shape of the patient's palate.

In particular, the main outer face follows the shape of the palate. It should be noted that the support 2 is here of reduced dimensions as compared to those of the patient's palate: nevertheless, on the part of the palate it covers, the outer main face conforms to the shape of the palate well. The outer main face is thus shaped in an impression of the palate.

In a particular way, the whole support 2 here conforms to the shape of the palate. In this way, the main outer face conforms to the shape of the palate when the support 2 is placed thereon, which makes it possible to attach the orthodontic appliance to the palate by means of a “suction cup” effect. In addition, the main inner face of the support 2 simulates the patient's palate. This allows the patient to move more easily from exercises performed with the appliance 1 to exercises performed without the appliance 1.

In addition, the appliance 1 has a peripheral rim 3 of the support 2.

The appliance 1 is thus designed in such a way that it does not extend to the vestibular surfaces of the upper and lower dental arches (except in extreme cases of unwanted malocclusion) but only inside the buccal cavity.

The rim 3 is also smooth on both its main inner and outer faces. The rim 3 therefore does not have a textured appearance like the support 2, which is intended here to simulate the patient's palate.

In this way, the main inner face of the appliance 1 does not have a ridge, which avoids the risk of injury to the patient.

The rim 3 is open here. Said rim 3 therefore edges only a part of the support 2. The rim 3 is typically shaped to simulate a dental arch.

Thus, when the appliance 1 is in place in the patient's buccal cavity, the support 2 rests against the palate and the rim 3 substantially extends along the upper dental arch, facing the palatal surface of the upper dental arch. On the other hand, the part of the support 2 closest to the bottom of the buccal cavity, towards the uvula, is not extended by the rim 3.

The rim 3 is substantially U-shaped to follow the dental arch.

In particular, the rim 3 is higher than the height of the upper arch in order to exceed at least the occlusion plane, when the appliance 1 is in place in the buccal cavity and the patient shuts his/her jaws. Preferably, the rim 3 substantially extends over the combined height of the upper and lower dental arch when the appliance 1 is in place in the buccal cavity and the patient shuts his/her jaws.

This helps to better protect the patient's teeth during language rehabilitation exercises. In particular, this ensures that the patient's tongue remains within the volume defined by the appliance 1, which prevents the tongue from coming into contact with one of the teeth.

Typically the rim 3 includes:
a first portion 5 forming the free end of the rim,
a second portion 6 extending in the extension of the first portion 5, and
a third portion 7 extending in the extension of the second portion 6 and connecting the rim 3 to the support 2.

When the appliance 1 is placed in the buccal cavity, the first portion 5 extends to the lower dental arch and the second portion 6 to the upper dental arch. Typically, the first portion 5 substantially extends from the collar of the lower dental arch to substantially the occlusion plane, the second portion 6 substantially extends from the occlusion plane to substantially the collar of the upper dental arch and the third portion 7 substantially extends from the collar of the upper dental arch to the edges of the palate.

Preferably, the appliance 1 is designed so that when the appliance 1 is in position in the buccal cavity, the rim 3 is not in contact with the patient's teeth.

This ensures that the appliance 1 can be used even if the patient already wears braces or other orthodontic appliances.

Typically, the appliance 1 is shaped so that in use the rim 3 extends between 1 mm and 3 mm, and preferably between 1.5 and 2.5 mm, back from the palatal surface of the upper dental arch and the lingual surface of the lower dental arch.

Preferably, and as will be seen later, the rim is defined at least in part according to the shape of the patient's buccal cavity. In particular, the third portion 7 is shaped to conform to the shape of the patient's palate.

This makes it easier to attach the appliance 1 to the palate by simply adhering it.

The appliance 1 is of course made of a material adapted to human anatomy. The appliance 1 is typically made of biocompatible resin.

In particular, the thickness of the appliance 1 is between 1 and 3 millimetres, and preferably between 1.2 and 2.5 millimetres. Preferably, the first portion 5 has a greater thickness than the rest of the appliance 1 (i.e. here than the other two portions 6, 7 and the support 2).

Preferably a thickness of the appliance 1, with the exception of the first portion, is chosen, between approximately 1.2 and 2 mm and a thickness of the first portion 5 between approximately 1.8 and 2.2 mm. Typically the thickness of appliance 1, with the exception of the first portion 5, is approximately 1.5 mm.

A method for manufacturing such an appliance 1 will now be described.

With reference to FIG. 4, and in a first step, a three-dimensional digital impression of at least part of a patient's buccal cavity is obtained when both jaws are shut. Preferably, the impression should include at least both dental arches and at least part of the patient's palate. Typically the impression includes the upper dental arch 10, the lower dental arch 11, the palate 12 as well as part of the mandible 13 and the maxilla 14.

The digital impression can be taken, for example, from a patient's medical imaging such as a three-dimensional Cone Beam Computed Tomography (CBCT), a three-dimensional dental scanner or a dental scanner of the Dentascan type. The digital impression is a digital file known to the dental profession. To this end, for the implementation of the invention, it will be possible either to create said digital impression (this step being known from the prior art, it will not be described in greater details here) or to recover it directly from the practitioner who examined the patient.

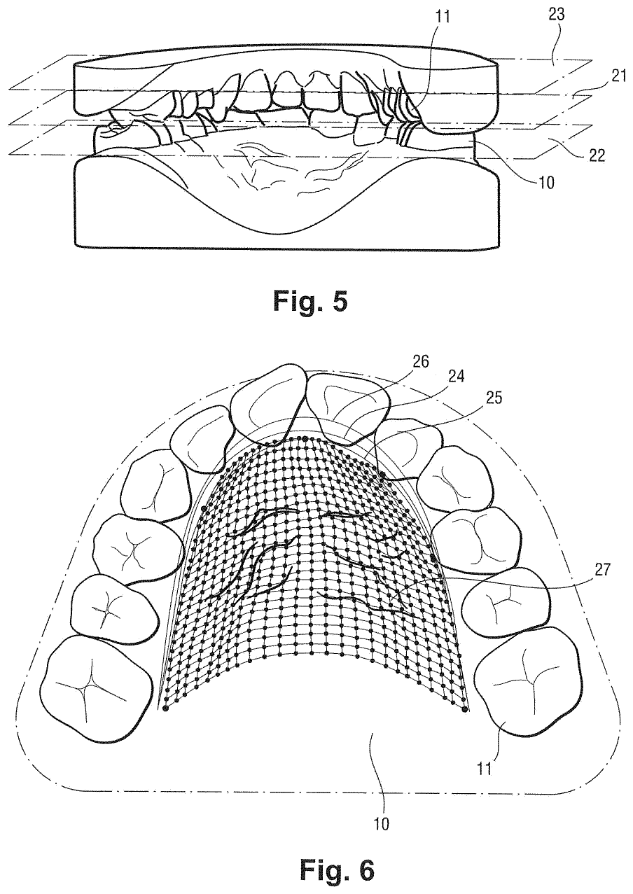

In a second step, and as shown in FIG. 5, three separate planes are then created in the impression.

A first plane 21 is created at the occlusal surfaces of the two dental arches 10, 11 so that said first plane 20 crosses as many teeth as possible. Preferably, said first plane 21 is defined so that it crosses first and foremost and at most the most turned-in teeth in the buccal cavity (i.e. the most cumbersome teeth for positioning the appliance 1 in the buccal cavity) and generally so that it crosses as many teeth as possible.

A second plane 22 is created at the level of the upper dental arch 10. Said second plane 22 is defined so that, for as many teeth as possible of the upper dental arch 10, said second plane 22 is arranged between the collars (remembering that a collar is the part of the tooth between the crown and the root) and the middle of the teeth.

A third plane 23 is created at the lower dental arch 11. Said third plane 23 is defined so that, for as many teeth as possible of the lower dental arch 11, said third plane 23 is arranged at the level of the collars.

Preferably, the three planes 21, 22, 23 are also defined so that at least two of the three planes are parallel to each other. Preferably, the three planes 21, 22, 23 are defined so that they are all parallel to each other.

With reference to FIG. 6 (the lower part of the buccal cavity not being visible here to simplify the reading of FIG. 6), for each of the three planes 21, 22, 23 above, a substantially U-shaped curve is then defined to follow the dental arch or arches associated with the plane considered without however said curve being in contact with the teeth. As indicated above, the curves are preferably chosen to extend between 1 mm and 3 mm, and preferably between 1.5 and 2.5 mm, from the palatal surface of the upper dental arch 10 and/or the lingual surface of the lower dental arch 11 depending on the plane considered.

Preferably, the curve 25 of the second plane 22 is also defined so as not to touch the retroincisive papilla so that the appliance 1 does not touch said papilla. Indeed, for a good positioning of the tongue, the tip of the tongue must rest on the palatal ridges or on an area of the palate set back from the retroincisive papilla located just behind the upper dental arch.

In particular, each curve 24, 25, 26 passes through at least five points of the associated plane.

For the first plane 21 the five points are:
a first point located at an equal distance from the four central incisors,
a second point located at an equal distance from the two premolars and the two canines on the left side,
a third point located at an equal distance from the two premolars and the two canines on the right side,
a fourth point located at an equal distance from the first two molars and the second two molars on the left side,
a fifth point located at an equal distance from the first two molars and the second two molars on the right side.

For the second plane 22 the five points are:
a first point located at an equal distance from the two upper incisors,
a second point located at an equal distance from the upper premolar and canine on the left side,
a third point located at an equal distance from the upper premolar and canine on the right side,
a fourth point located at an equal distance from the upper first molar and second molar on the left side,
a fifth point located at an equal distance from the upper first molar and second molar on the right side.

For the third plane 23 the five points are:
a first point located at an equal distance from the two lower incisors,
a second point located at an equal distance from the lower premolar and canine on the left side,
a third point located at an equal distance from the lower premolar and canine on the right side,
a fourth point located at an equal distance from the lower first molar and second molar on the left side,
a fifth point located at an equal distance from the lower first molar and second molar on the right side.

As an option, it is then possible to create a three-dimensional model 27 of the palate extending to the curve 25 formed in the second plane 22, for example by filtering. It should be noted that it is also possible not to create such a finalised model 27, the definition of the curves 25 alone being sufficient to model at least part of the patient's palate, and then to create an external contour of the model of the appliance 1 from the three curves 24, 25, 26 mentioned above (and optionally the model 27) thus forming an outer face of the support 2 and the rim 3 respectively. In particular, it should be noted that the three curves 24, 25, 26 mentioned above allow the support 2 but also the rim 3 to be personalized to the patient. The rim 3 is smooth but follows a particular curvature specific to the patient.

This makes it possible to define in the long term an appliance 1 that can fit in the buccal cavity by simply adhering to the palate.

With reference to FIG. 1, said external contour is then extruded to model the appliance 1.

A model of the appliance 1 specific to the patient and his/her anatomy is then obtained. This ensures that the appliance 1 will not come into contact with one of the patient's teeth but also that the appliance 1 will adhere well to the palate. It is also ensured here that the appliance 1 will not touch the retroincisive papilla.

The appliance 1 is then manufactured from this model, for example by three-dimensional impression. This makes it possible to use computer-aided manufacturing.

An appliance 1 adapted to each patient is thus manufactured in a relatively simple and inexpensive way.

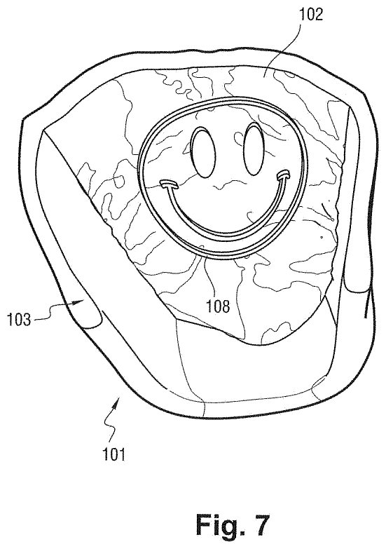

With reference to FIG. 7, the appliance according to the second embodiment of the invention is identical to the appliance according to the first embodiment, with the difference that the appliance 101 has at least one language reception area.

In particular, this reception area is here a raised area 108 arranged on the appliance 101 at approximately the level where the tip of the user's tongue should normally rest and press during a swallow.

It is therefore relatively easy for a patient to learn to position his/her tongue correctly since he/she only needs to feel the raised area 108 with the tip of his/her tongue to know that his/her tongue is correctly placed.

Preferably, this reception area is shaped in a drawing (a figure, a number, a letter, an image, an emoticon . . . ). This makes it possible to give the appliance 101 a more reassuring and/or playful appearance, which makes it easier to accept the treatment and the appliance 101, especially for young children.

Of course, the invention is not limited to the specific embodiments described above, but on the contrary encompasses any alternative solution within the scope of the invention.

In particular, although here the entire support simulates the palate, only a part of the support can be shaped to simulate the palate. For example, the main inner face of the support, which the patient's tongue can touch, may be smooth.

In the same way, although the rim here is smooth, the rim can be shaped to simulate the portion of the palate it represents.

If the appliance has a language reception area, alternatively or in addition, this area may look different from what has been indicated. For example, the reception area may have an opening in the appliance. For example, the patient will be able to actually touch his/her palate through the appliance during his/her language rehabilitation. Of course, the same appliance may include several identical or different reception areas.

The appliance may contain elements other than those indicated. For example, the appliance may have a pressure sensor. For example, although not exclusively, said sensor will be able to measure the thrust exerted by the tongue during a swallow.

The appliance may also include one or more sensor(s) so that it is possible to produce statistics from the information indicated by these sensors. These sensors may be associated with at least one memory carried by the appliance to record the data provided by the sensors and/or remote communication means with a computing appliance to process the data provided by the sensors and/or a miniature computing appliance directly carried by the appliance to process the data at least in part at the appliance. This will allow for patient-specific and preferably long-term follow-up.

The sensor(s) can be chosen from the following list: a pressure sensor, a position sensor, a distance sensor, a deviation sensor, a displacement sensor, a thermal sensor, a biochemical sensor, an optical sensor, a camera.

Although here the orthodontic appliance is shaped to extend away from the dental arches, the orthodontic appliance can be shaped to extend to at least one of the dental arches and/or the occlusion plane. This will allow the orthodontic appliance to touch the teeth.

In addition, although here the orthodontic appliance entirely extends within the patient's buccal cavity, the orthodontic appliance may extend partially outside the buccal cavity. It may also be possible for the appliance to be attached, even temporarily, to one or both of the patient's dental arches. However, it should be noted that because of its conformation to the shape of the palate, the appliance can in any case stand alone against the palate without the help of these dental arches (which will only be there to perform other work on the teeth, for example). It is only conceivable that the appliance could be combined with another appliance with a connection to the dental arches even if the appliance can stand alone against the palate.

1. An orthodontic appliance for a patient comprising:
a support of which at least one outer face is shaped to conform to the shape of the patient's palate, the support being intended to be positioned against the patient's palate,
a peripheral rim of said support intended to be arranged at least facing a palatal face of the upper dental arch when the support is placed against the palate.

2. The appliance according to claim 1, shaped to extend fully into the patient's buccal cavity.

3. An appliance according to claim 1, wherein the inner surface of the support is also shaped to reproduce the shape of the palate.

4. An appliance according to claim 1, wherein the rim is smooth.

5. An appliance according to claim 1, wherein the rim globally has the shape of a U.

6. An appliance according to claim 1, wherein the rim has a height greater than a height of the upper dental arch in order to extend beyond the occlusion plane.

7. An appliance according to claim 6, wherein the rim extends at least over the combined height of the upper and lower dental arch.

8. An appliance according to claim 6, wherein the rim extends between 1 mm and 3 mm back from a palatal face of the upper dental arch.

9. An appliance according to claim 6, comprising a patient's tongue reception area comprising at least one orifice.

10. An appliance according to claim 6, comprising a patient's tongue reception area comprising a raised area.

11. A method for manufacturing an orthodontic appliance comprising the following steps:
obtaining a three-dimensional impression of at least part of the patient's buccal cavity,
creating in said impression at least one plane at the occlusal surfaces of the two dental arches of said impression to model at least a part of the patient's palate,
creating a three-dimensional model of the orthodontic appliance,
creating the orthodontic appliance from said model.

12. A manufacturing method according to claim 11, wherein the plane is created so that it crosses as many teeth as possible.

13. A manufacturing method according to claim 11, wherein the plane is created so that it crosses first and foremost and at most the most in-turned teeth in the buccal cavity.

14. A manufacturing method according to claim 11, wherein at least two other planes are created in the impression, one associated with the upper and the other with the lower dental arch to model at least a part of the patient's palate.

15. A manufacturing method according to claim 11, wherein a curve is defined passing through at least five points of the plane.

16. A manufacturing method according to claim 11, wherein the palatal papilla and the lateral rims of the mandible are also taken into account for the three-dimensional modelling of the orthodontic appliance.
